(19) United States
(12) Patent Application Publication
(10) Pub. No.: US 2006/0239730 A1
(43) Pub. Date: Oct. 26, 2006

(54) Scanner with flexible cover

(75) Inventor: Jian-Hua Fei, Jiangsu (CN)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/399,426

(22) Filed: Apr. 7, 2006

(30) Foreign Application Priority Data
Apr. 11, 2005 (TW) 94111312

(51) Int. Cl. G03G 15/00

(52) U.S. Cl. 399/380

(57) ABSTRACT

A scanner with a flexible cover. The scanner comprises a main body, a flexible cover joined to the main body and a shaft within the main body. The flexible cover is made of flexible material. One end of the flexible cover is connected to the shaft, and the flexible cover is wound on the shaft when accommodated in the main body.

### BACKGROUND

The invention relates to a scanner, and in particular to a scanner with a flexible cover.

A conventional scanner typically has a rigid cover to cover a scanning object for better scan quality. The rigid cover of the conventional scanner, however, makes a full contact of a scanning object of considerable thickness with the scanner difficult, for example, scanning a book. This typically results in poor scan quality.

### SUMMARY

An embodiment of a scanner of the invention comprises a main body and a flexible cover made of flexible material joined to the main body for covering a scanning object.

The scanner further comprises a shaft disposed within the main body. One end of the flexible cover is connected to the shaft, and the flexible cover is wound on the shaft when accommodated in the main body.

The scanner further comprises an elastic member or a link element connecting the flexible cover and the shaft, wherein the flexible cover is wound on the shaft by rotation of the shaft driven by the elastic force of the elastic member or a knob connected to the shaft.

The scanner further comprises a latching element disposed on the other end of the flexible cover. The latching element engages the main body enabling the flexible cover to engage the main body, thereby covering the scanning object.

The scanner further comprises a ferromagnetic element disposed on one end of the flexible cover and a magnet disposed on the main body. The ferromagnetic element attracts and joins the magnet enabling the flexible cover to engage the main body, thereby covering the scanning object.

The scanner further comprises at least one hole defined on one end of the flexible cover and at least one latch disposed on the main body. The latch engages the hole enabling the flexible cover to engage the main body, thereby covering the scanning object.

### BRIEF DESCRIPTION OF THE DRAWINGS

The invention can be more fully understood by reading the subsequent detailed description and examples with references made to the accompanying drawings, wherein:

FIG. 1a is a schematic view of an embodiment of a scanner of the invention;

FIG. 1b is a schematic view of another embodiment of a scanner of the invention;

FIG. 1c is a schematic view of another embodiment of a scanner of the invention;

FIG. 2 is a schematic view of a flexible cover accommodated in a main body of the scanner;

FIG. 3 is a schematic view depicting a flexible cover connected to a shaft of the embodiment of FIGS. 1a to 1c;

FIG. 4 is a schematic view of an embodiment of a scanner of the invention;

FIG. 5 is a schematic view depicting a flexible cover connected to a shaft of the embodiment of FIG. 4; and

FIG. 6 is a cross section of a flexible cover of the invention.

### DETAILED DESCRIPTION

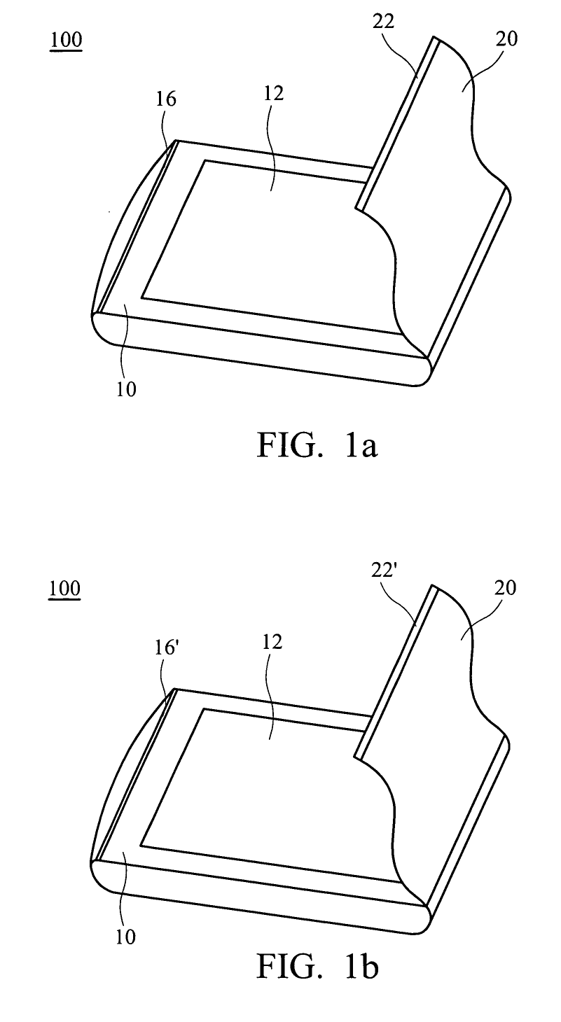

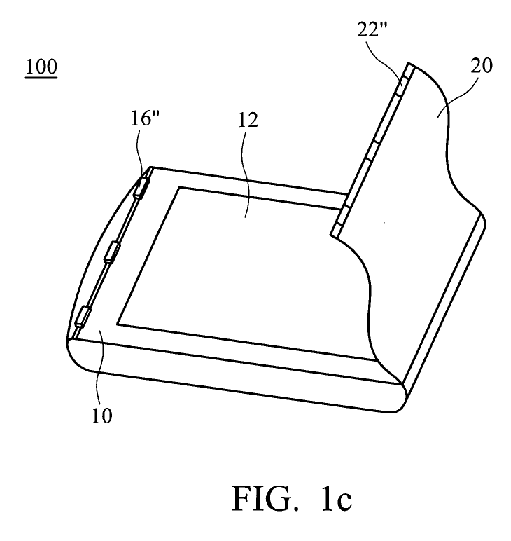

Referring to FIG. 1a, a scanner 100 comprises a main body 10 and a flexible cover 20 made of flexible material. The flexible cover 20 is elastic and capable of rolling up or stretching in a specific range. A latching member 22 is disposed on one end of the flexible cover 20, and a groove 16 is disposed on the main body 10 corresponding to the latching member 22. The latching member 22 engages the groove 16 to enable the flexible cover 20 to be positioned on the main body 10, thereby covering a glass plate 12 bearing a scanning object.

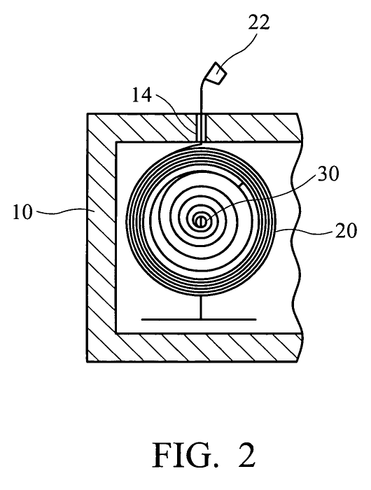

In this embodiment, the flexible cover 20 can be accommodated in the main body 10 as shown in FIG. 2. A shaft 30 is disposed in the main body 10. One end of the flexible cover 20 is connected to the shaft 30, and the other end thereof is free. The flexible cover 20 is wound through a slot 14 on the shaft 30 by means of rotation, and is thereby accommodated in the main body 10. Only the latching member 22 is left outside the main body 10. In addition, as the shaft 30 is disposed near one end of the main-body 10, motion of a scan module (not shown) is not affected.

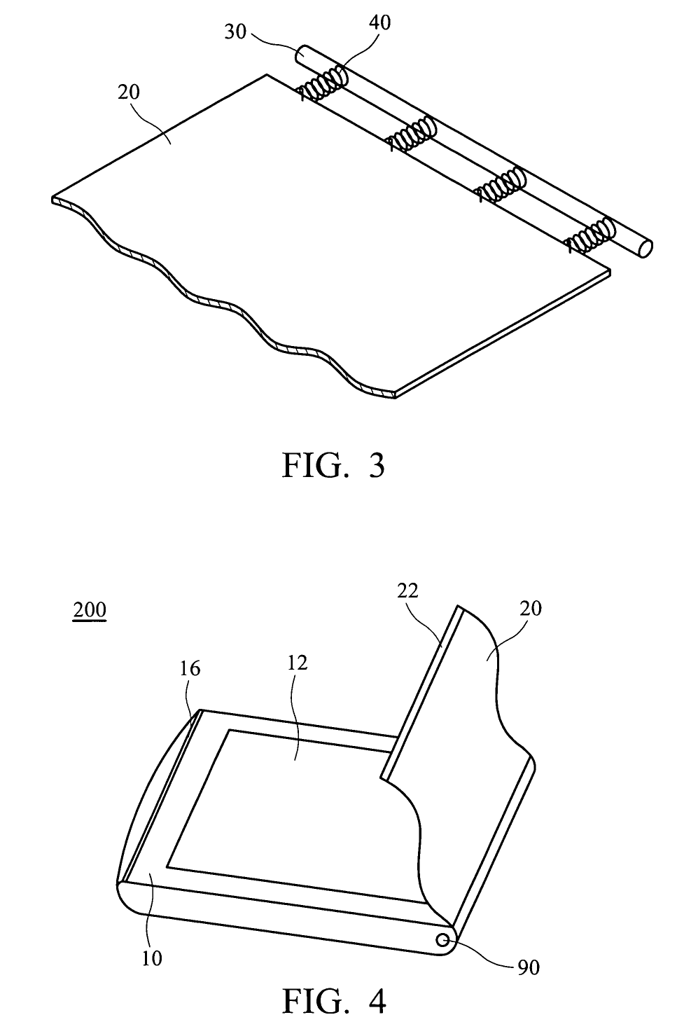

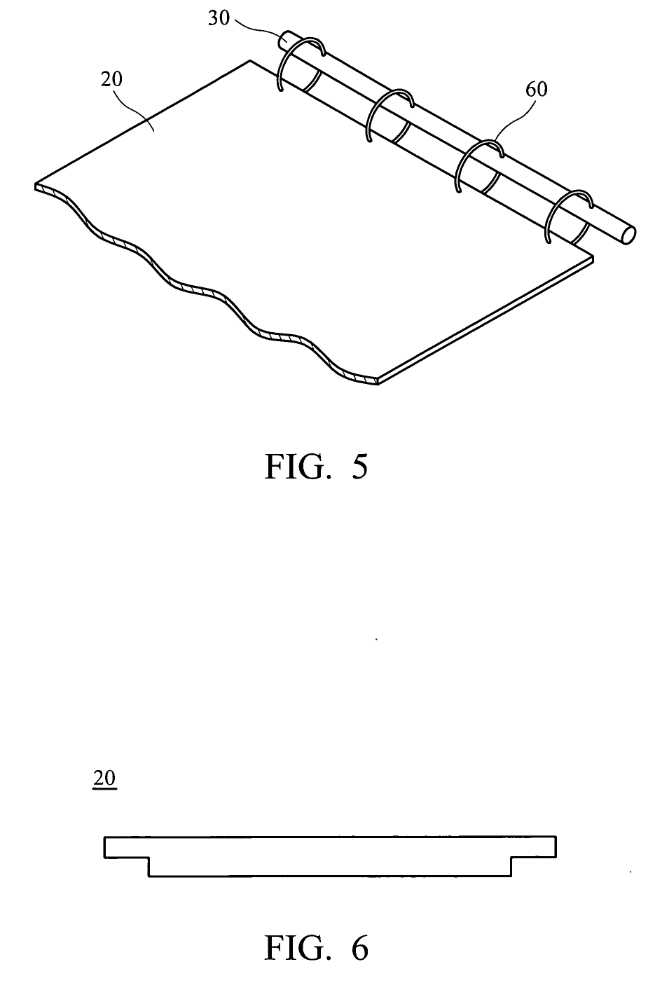

In this embodiment, an elastic element (spring) 40 connects the flexible cover 20 and the shaft 30 as shown in FIG. 3. When an object is to be scanned, the flexible cover 20 is pulled to the front end of the main body 10 and stretched tightly, elongating the elastic element 40. Latching member 22 is engaged to the groove 16 enabling the flexible cover 20 to cover the glass plate 12. When the scan is complete, the flexible cover 20 is pulled up and released. Because the elastic element 40 is elongated, the shaft 30 is rotated by the elastic force to roll up the flexible cover 20, whereby the flexible cover 20 is accommodated in the main body 10. When the scanner 100 is not used, the flexible cover 20 can be pulled out to cover the glass plate 12 for the sake of protection.

Another embodiment of the invention is depicted in FIG. 1b. A ferromagnetic element 22′ is disposed on one end of the flexible cover 20, and a magnet 16′ is disposed on the main body 10 corresponding to the ferromagnetic element 22′. The ferromagnetic element 22′ is attracted to the magnet 16′ to enable the flexible cover 20 to engage the main body 10, thereby the flexible cover 20 covering the glass plate 12.

Another embodiment of the invention is depicted in FIG. 1c. At least one hole 22″ is formed on the flexible cover, and at least one latch 16″ is disposed on the main body 10 corresponding to the hole 22″. The latch 16″ engages the hole 22″ enabling the flexible cover 20 to engage the main-body 10, thereby the flexible cover 20 covering the glass plate 12.

FIG. 4 depicts another embodiment of the invention. In this embodiment, the flexible cover 20 is connected to the shaft 30 by a link element 60. The shaft 30 is connected to a knob 90 protruding from the main body 10. When the knob 90 is rotated, the shaft 30 is rotated and the flexible cover 20 is wound on the shaft 30. When an object is to be scanned, the flexible cover 20 is pulled out and the latching member 22 is engaged with the groove 16. When the scan is finished, the flexible cover 20 is pulled up and the knob 90 is rotated to wind the flexible cover 20 on the shaft 30.

In general, the glass plate 12 is depressed from the main body 10. As shown in FIG. 4, The flexible cover 20 has a central portion thicker than the lateral sides thereof to easily cover the depressed glass plate 12. Thus the scanning object is pressed closely against the glass plate 12 for better scan quality.

For even better scan quality, the described latching element, ferromagnetic element, hole and the like can be disposed on lateral sides of the flexible cover 20, and the corresponding groove, magnet, and latch can also be disposed on the main body 10.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanner, comprising:
a main body;
a flexible cover made of flexible material joined to the main body, and covering a scanning object.

2. The scanner as claimed in claim 1 further comprising a shaft within the main body, wherein a first end of the flexible cover is connected to the shaft, and the flexible cover is wound on the shaft when accommodated in the main body.

3. The scanner as claimed in claim 2 further comprising an elastic member connecting the flexible cover and the shaft, wherein the flexible cover is wound on the shaft by elastic force of the elastic member.

4. The scanner as claimed in claim 3 further comprising a latching element disposed on a second end of the flexible cover which is opposing to the first end of the flexible cover, wherein the latching element engages the main body to enable the flexible cover to engage the main body, thereby covering the scanning object.

5. The scanner as claimed in claim 3 further comprising a ferromagnetic element disposed on a second end of the flexible cover which is opposing to the first end of the flexible cover and a magnet disposed on the main body, wherein the ferromagnetic element is attracted to join with the magnet to enable the flexible cover to engage the main body, thereby covering the scanning object.

6. The scanner as claimed in claim 3 further comprising at least one hole defined on a second end of the flexible cover which is opposing to the first end of the flexible cover and at least one latch disposed on the main body, wherein the latch engages the hole to enable the flexible cover to engage the main body, thereby covering the scanning object.

7. The scanner as claimed in claim 3 further comprising at least one hole defined on a second end of the flexible cover which is opposing to the first end of the flexible cover and at least one latch disposed on one side of the main body, wherein the latch engages the hole to enable the flexible cover to engage the main body, thereby covering the scanning object.

8. The scanner as claimed in claim 2 further comprising a link element connecting the flexible cover and the shaft, wherein the flexible cover is wound on the shaft by rotation of the shaft.

9. The scanner as claimed in claim 8 further comprising a knob disposed on the main body and connected to the shaft, wherein the shaft is rotated by rotating the knob so as to wind the flexible cover on the shaft.

10. The scanner as claimed in claim 9 further comprising a latching element disposed on a second end of the flexible cover which is opposing to the first end of the flexible cover, wherein the latching element engages the main body to enable the flexible cover to engage the main body, thereby covering the scanning object.

11. The scanner as claimed in claim 9 further comprising a ferromagnetic element disposed on a second end of the flexible cover which is opposing to the first end of the flexible cover and a magnet disposed on the main body, wherein the ferromagnetic element is attracted to join with the magnet to enable the flexible cover to engage the main body, thereby covering the scanning object.

12. The scanner as claimed in claim 9 further comprising at least one hole defined on a second end of the flexible cover which is opposing to the first end of the flexible cover and at least one latch disposed on the main body, wherein the latch engages the hole to enable the flexible cover to engage the main body, thereby covering the scanning object.

13. The scanner as claimed in claim 9 further comprising at least one hole defined on a second end of the flexible cover which is opposing to the first end of the flexible cover and at least one latch disposed on one side of the main body, wherein the latch engages the hole to enable the flexible cover to engage the main body, thereby covering the scanning object.

14. The scanner as claimed in claim 1, wherein the flexible cover comprises two lateral sides and one central portion which is thicker than the two lateral sides.
